(19) United States
(12) Patent Application Publication
(10) Pub. No.: US 2005/0060860 A1
(43) Pub. Date: Mar. 24, 2005

(54) Tire valve puller

(76) Inventor: Hsin Fa Kang, Tainan City (TW)

Correspondence Address: Kang Hsin Fa, P.O. Box 90, Tainan City, 704, TW

(21) Appl. No.: 10/666,036

(22) Filed: Sep. 22, 2003

(51) Int. Cl. B23P 19/04

(52) U.S. Cl. 29/267

(57) ABSTRACT

A tire valve puller in the invention has a pulling rod and a joint, wherein the pulling rod includes an open slot, a bent part and a plastic covering support provided with engagement grooves thereon; the joint is pivoted above the open slot and covered outside around by a sleeve. A user may firstly push the sleeve downwards to make the joint connected with a tire valve to clamp the valve firmly, secondly make one of the engagement grooves of the covering support securely engaged with a flange of a wheel rim forming a fulcrum, and finally hold the grip with one hand to make the pulling rod pressed against the fulcrum and apply force toward a tire to pull the valve outwardly to be protruded out of the wheel rim without deforming the valve to influence its using effect or damaging the wheel flange under improper force, convenient in operation.

### BACKGROUND OF THE INVENTION

1. Field of the Invention

This invention relates to a tire valve puller, particularly to one having a pulling rod and a joint, wherein the pulling rod is provided with an open slot, a plastic covering support and a bent part, the plastic covering support provided with a plurality of engagement grooves disposed thereon; the joint is pivoted above the open slot of the pulling rod and covered outside around by a sleeve, whereby a user may firstly push the sleeve downwards to make the joint connected with a tire valve so as to clamp the tire valve firmly, secondly make one of the plurality of engagement grooves of the covering support securely engaged with a flange of a wheel rim of which engaging location can be functioned as a fulcrum, and finally hold the grip of the pulling rod with one hand to make the pulling rod tightly pressed against the fulcrum and further apply force in a direction toward a tire so as to pull the tire valve outwardly to be protruded out of the wheel rim without wearing external threads of the tire valve or deforming the tire valve to influence its using effect, and without damaging the flange of the wheel rim under improper force of the pulling rod, very convenient in operation.

2. Description of the Prior Art

Generally speaking, when a vehicle tire gets flat, a tire valve will be withdrawn into a wheel rim, thus unable to put air into the tire. In the situation, a tool for pulling the tire valve out outwardly to be protruded out of the wheel rim is required. However, in pulling the tire valve, many conventional known tools often damage external threads of the tire valve, or even worse, deform the tire valve under improper force so that a tire inflator is hard to put air into the tire smoothly, and a tire valve cap is also unable to be firmly screwed with the tire valve and thus fallen off.

### SUMMARY OF THE INVENTION

The main purpose of the present invention is to provide a tire valve puller capable of conveniently and securely clamping a tire valve to pull the tire valve outwardly to be protruded out of a wheel rim without damaging the tire valve.

One primary feature of the present invention is to provide a tire valve puller mainly including:
a joint having an insertion bore disposed therein, at least two retaining holes disposed on a circumferential wall thereof, at least two slots disposed on the circumferential wall thereof in communication with the insertion bore, and an annular groove disposed adjacent an upper end of an outer surface of the circumferential wall thereof;
at least two elastic clip members capable of being respectively disposed on the circumferential wall of the joint, and each having a retaining part disposed at a lower end thereof and an engagement head disposed at an upper end thereof;
a spring capable of being mounted around the joint;
a sleeve capable of being covered outside around the joint, and having a stop edge disposed at an upper portion of an inner surface thereof and a recessed chamber disposed at a lower portion of the inner surface thereof, the inner surface of the sleeve designed to be a tapered plane provided with a top wider than a bottom; and,
a positioning member capable of being engaged with the annular groove of the joint.

One another feature of the present invention is to provide a tire valve puller mainly including:
a pulling rod having a plastic covering support sleeved thereon and a grip disposed at the other end thereof, said covering support provided with a plurality of engagement grooves disposed thereon.

One further feature of the present invention is to provide a tire valve puller mainly including:
a pulling rod provided with a bent part disposed thereon.

### BRIEF DESCRIPTION OF DRAWINGS

This invention will be better understood by referring to the accompanying drawings, wherein:

FIG. 1 is a perspective view showing an assemblage of a tire valve puller in the present invention;

FIG. 2 is an exploded perspective view of the tire valve puller in the present invention;

FIG. 3 is a sectional view showing the assemblage of the tire valve puller in the present invention;

FIG. 4 is a schematic view of the tire valve puller in the present invention, showing a sleeve is pushed downwards;

FIG. 5 is a sectional schematic view of the tire valve puller in the present invention in use; and,

FIG. 6 is a perspective schematic view of the tire valve puller in the present invention in use.

### DETAILED DESCRIPTION OF THE PREFERRED EMBODIMENT

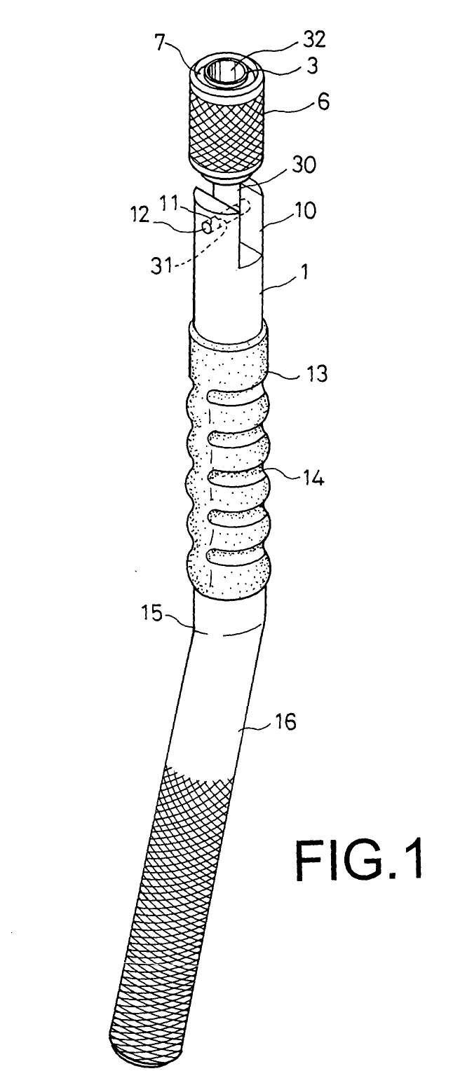

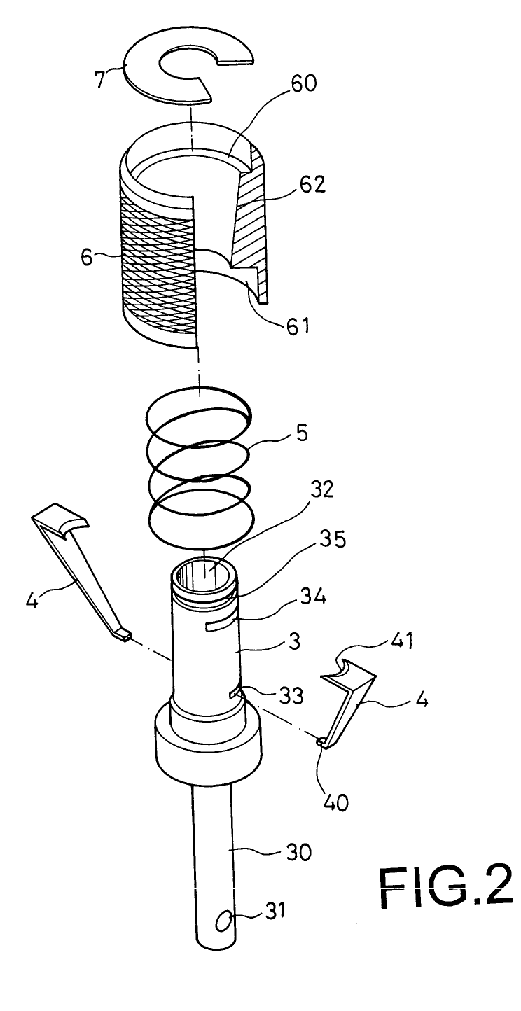

A preferred embodiment of a tire valve puller in the present invention, as shown in FIGS. 1, 2 and 3, mainly includes a pulling rod 1, a joint 3, two elastic clip members 4, a spring 5, a sleeve 6 and a positioning member 7.

The pulling rod 1 has one end provided with an open slot 10 disposed thereon, two through holes 11 oppositely disposed on a circumferential wall thereof in communication with the open slot 10, a plastic covering support 13 disposed thereon, a bent part 15 disposed below the plastic covering support 13 and bent at a predetermined angle, and a grip 16 disposed at an end portion of the bent part 15. The plastic covering support 13 is provided with a plurality of curved engagement grooves 14 disposed thereon. A pivot pin 12 is capable of being passed through the two through holes 11.

The joint 3 capable of being pivoted above the open slot 10 of the pulling rod 1 has a connecting rod 30 disposed at a lower end thereof, an insertion bore 32 disposed therein, two retaining holes 33 oppositely disposed on a circumferential wall thereof, two slots 34 oppositely disposed on the circumferential wall thereof in communication with the insertion bore 32, and an annular groove 35 disposed adjacent an upper end of an outer surface of the circumferential wall thereof. The connecting rod 30 is provided with a through hole 31 disposed thereon for being passed through by the pivot pin 12.

Two elastic clip members 4 are capable of being oppositely disposed on the circumferential wall of the joint 3, and each has a retaining part 40 disposed at a lower end thereof and a curved engagement head 41 disposed at an upper end thereof.

The spring 5 is capable of being mounted around the joint 3.

The sleeve 6 capable of being covered outside around the joint 3 has a stop edge 60 disposed at an upper portion of an inner surface thereof and a recessed chamber 61 disposed at a lower portion of the inner surface thereof. The inner surface of the sleeve 6 is designed to be a tapered plane 62 provided with a top wider than a bottom.

The positioning member 7 is capable of being engaged with the annular groove 35 of the joint 3.

In assembling, referring to FIGS. 1, 2 and 3, firstly assemble the two elastic clip members 4 oppositely on the circumferential wall of the joint 3 with the retaining parts 40 of the two elastic clip members 4 respectively inserted into the corresponding two retaining holes 33 of the joint 3 and with the curved engagement heads 41 of the two elastic clip members 4 respectively extended through the corresponding two slots 34 of the joint 3.

Secondly, mount the spring 5 around the joint 3, and then cover the sleeve 6 outside around the joint 3 to make the spring 5 accommodated in the recessed chamber 61 of the sleeve 6 and to make the two elastic clip members 4 located inside the tapered plane 62 of the sleeve 6, by which the two elastic clip members 4 is confined by the tapered plane 62 of the sleeve 6 to make the curved engagement heads 41 of the two elastic clip members 4 further extended into the insertion bore 32 of the joint 3.

Thirdly, engage the positioning member 7 with the annular groove 35 of the joint 3 so as to affix the sleeve 6 outside around the joint 3 in place.

Finally, place the connecting rod 30 of the joint 3 into the open slot 10 of the pulling rod 1 with the thought hole 31 of the connecting rod 30 aligned with the two through holes 11 of the pulling rod 1, and then pass the pivot pin 12 through the two through holes 11 of the pulling rod 1 as well as the though hole 31 of the connecting rod 30 so as to pivot the joint 3 with the pulling rod 1, by which a whole assemblage of the tire valve puller of the present invention is completed.

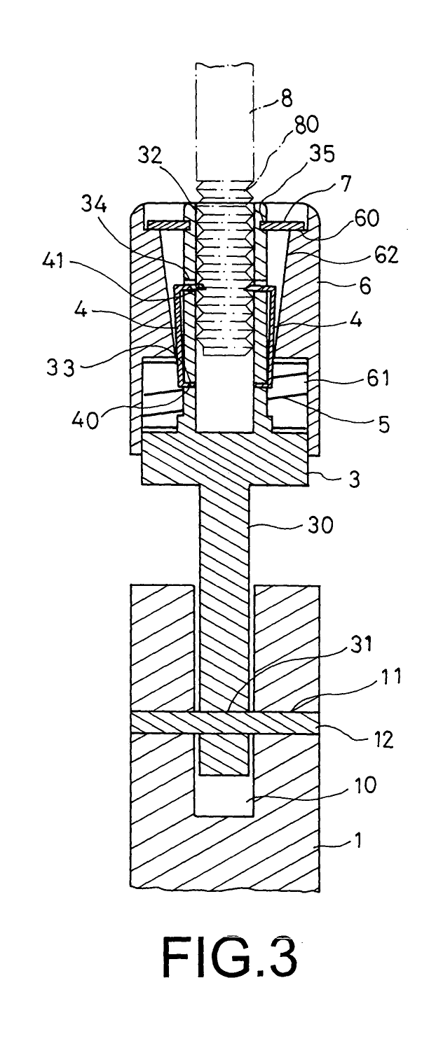

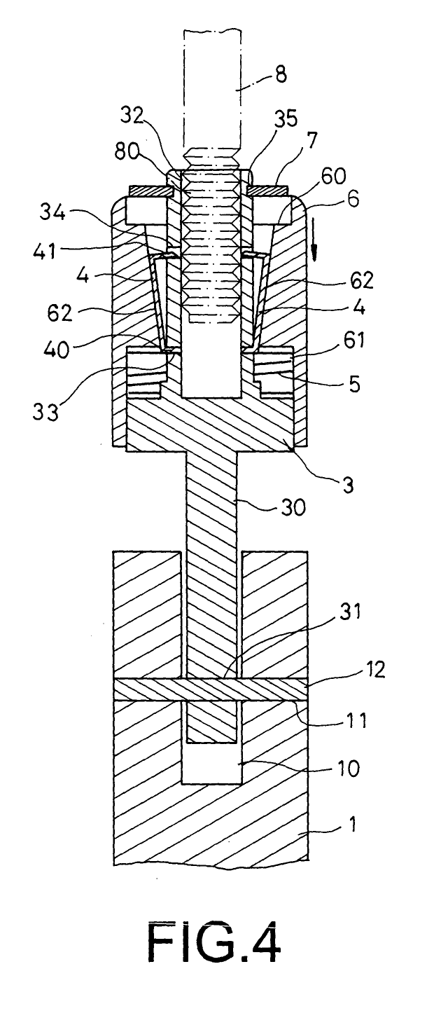

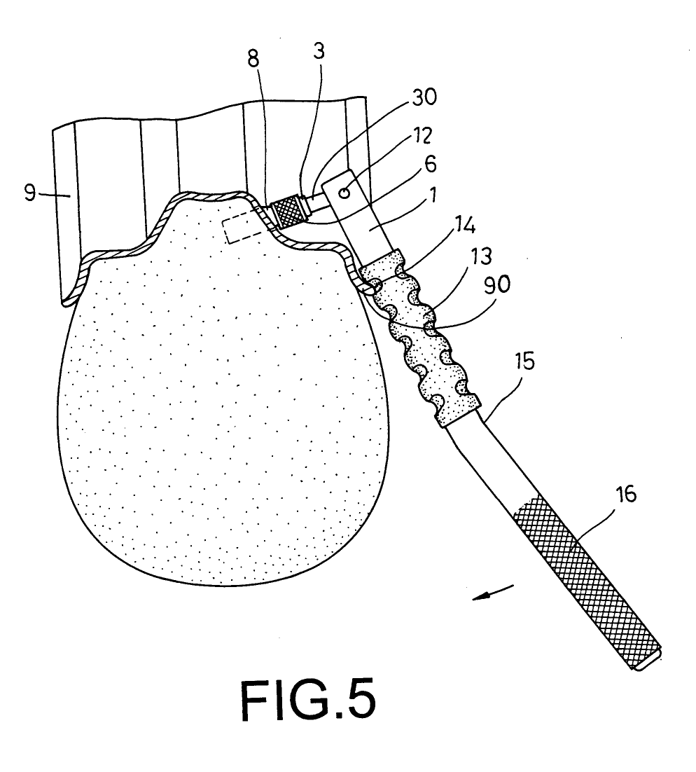

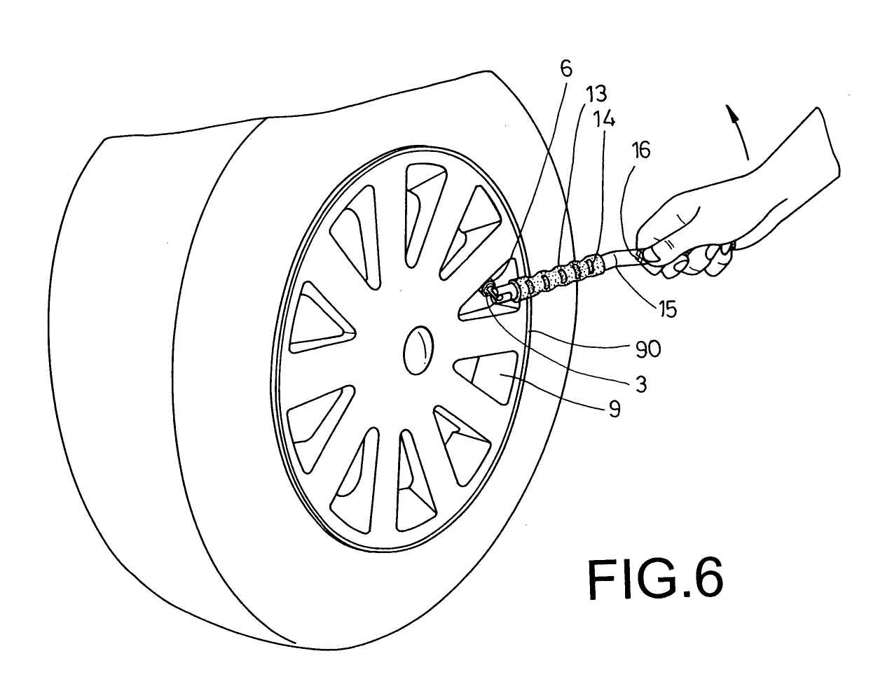

In using, referring to FIGS. 3, 4, 5 and 6, when a tire valve 8 is withdrawn into a wheel rim 9, firstly push the sleeve 6 downwards with hands to press the spring 5 in a compressed status. At this time, the two elastic clip members 4 will get free of the confinement of the tapered plane 62 of the sleeve 6 and stretch outwardly under their own elasticity to make the engagement heads 41 of the two elastic clip members 4 moved out of the insertion bore 32 of the joint 3, thereby allowing the insertion bore 32 of the joint 3 to be connected with the tire valve 8.

Secondly, put the sleeve 6 away from the hands so that the sleeve 6 is immediately moved back to its initial position under the resilience of the spring 5 to make the tapered plane 62 of the sleeve 6 confine the two elastic clip members 4 therein to force the engagement heads 41 of the two elastic clip members 4 to be extended into the insertion bore 32 of the joint 3 and engaged with external threads 80 of the tire valve 8 so as to clamp the tire valve 8 firmly.

Finally, make one of the plurality of curved engagement grooves 14 of the covering support 13 securely engaged with a flange 90 of the wheel rim 9 of which engaging location can be functioned as a fulcrum, and then hold the grip 16 of the pulling rod 1 with one hand to make the pulling rod 1 tightly pressed against the fulcrum and further apply force in a direction toward a tire (not numbered) so as to pull the tire valve 8 outwardly to be protruded out of the wheel rim 9 without wearing the external threads 80 of the tire valve 8 or deforming the tire valve 8 to influence its using effect, very convenient in operation. Moreover, since the covering support 13 is made of plastic material, the pulling rod 1 will not damage the flange 90 of the wheel rim 9 when the pulling rod 1 is tightly pressed against the fulcrum in pulling the tire valve 8 outwardly.

After the tire valve 8 is pulled outwardly, only to push the sleeve 6 downwards to press the spring 5 in a compressed status again. At this time, the two elastic clip members 4 will get free of the confinement of the tapered plane 62 of the sleeve 6 and stretch outwardly under their own elasticity to make the engagement heads 41 of the two elastic clip members 4 moved out of the insertion bore 32 of the joint 3 without being engaged with the external threads 80 pf the tire valve 8, thereby allowing the joint 3 to be removed from the tire valve 8, very convenient in operation.

While the preferred embodiment of the invention has been described above, it will be recognized and understood that various modifications may be made therein and the appended claims are intended to cover all such modifications that may fall within the spirit and scope of the invention.

1. A tire valve puller comprising:
a pulling rod having one end provided with an open slot disposed thereon and two through holes oppositely disposed on a circumferential wall thereof in communication with said open slot, a pivot pin capable of being passed through said two through holes;
a joint capable of being pivoted above said open slot of said pulling rod and having a connecting rod disposed at a lower end thereof, said connecting rod provided with a through hole disposed thereon for being passed through by said pivot pin; and,
characterized by said joint having an insertion bore disposed therein, at least two retaining holes disposed on a circumferential wall thereof, at least two slots disposed on said circumferential wall thereof in communication with said insertion bore, and an annular groove disposed adjacent an upper end of an outer surface of said circumferential wall thereof;
at least two elastic clip members capable of being respectively disposed on said circumferential wall of said joint, and each having a retaining part disposed at a lower end thereof and an engagement head disposed at an upper end thereof;
a spring capable of being mounted around said joint;
a sleeve capable of being covered outside around said joint, and having a stop edge disposed at an upper portion of an inner surface thereof and a recessed chamber disposed at a lower portion of said inner surface thereof, said inner surface of said sleeve designed to be a tapered plane provided with a top wider than a bottom;
a positioning member capable of being engaged with said annular groove of said joint; and,
whereby a user may firstly push said sleeve downwards with hands to compress said spring so that said at least two elastic clip members can get free of the confinement of said tapered plane of said sleeve and stretch outwardly under their own elasticity to make said engagement heads of said at least two elastic clip members moved out of said insertion bore of said joint to allow said joint to be connected with a tire valve, and then put said sleeve away from the hands so that said sleeve is immediately moved back to its initial position under the resilience of said spring to make said tapered plane of said sleeve confine said at least two elastic clip members therein to force said engagement heads of said at least two elastic clip members to be extended into said insertion bore of said joint and engaged with external threads of said tire valve, thereby clamping said tire valve firmly for the convenience of pulling said tire valve outwardly to be protruded out of a wheel rim without wearing said external threads of said tire valve or deforming said tire valve to influence its using effect, very convenient in operation.

2. A tire valve puller comprising:
a pulling rod having one end provided with an open slot disposed thereon and two through holes oppositely disposed on a circumferential wall thereof in communication with said open slot, a pivot pin capable of being passed through said two through holes;
a joint capable of being pivoted above said open slot of said pulling rod and having a connecting rod disposed at a lower end thereof, said connecting rod provided with a through hole disposed thereon for being passed through by said pivot pin; and,
characterized by said pulling rod having a plastic covering support sleeved thereon and a grip disposed at the other end thereof, said covering support provided with a plurality of engagement grooves disposed thereon; and,
whereby a user may firstly make one of said plurality of engagement grooves of said covering support securely engaged with a flange of a wheel rim of which engaging location can be functioned as a fulcrum, and then hold said grip of said pulling rod with one hand to make said pulling rod tightly pressed against said fulcrum and further apply force in a direction toward a tire so as to pull a tire valve outwardly to be protruded out of said wheel rim without damaging said flange of said wheel rim under improper force of said pulling rod, very convenient in operation.

3. A tire valve puller comprising:
a pulling rod having one end provided with an open slot disposed thereon and two through holes oppositely disposed on a circumferential wall thereof in communication with said open slot, a pivot pin capable of being passed through said two through holes;
a joint capable of being pivoted above said open slot of said pulling rod and having a connecting rod disposed at a lower end thereof, said connecting rod provided with a through hole disposed thereon for being passed through by said pivot pin; and,
characterized by said pulling rod provided with a bent part disposed thereon for the convenience of applying force to quickly pull a tire valve outwardly.
